(19) United States
(12) Patent Application Publication
(10) Pub. No.: US 2004/0054771 A1
(43) Pub. Date: Mar. 18, 2004

(54) Method and apparatus for the remote retrieval and viewing of diagnostic information from a set-top box

(76) Inventors: Glen E. Roe, Simi Valley, CA (US); Marvin C. Carlberg, Los Angeles, CA (US)

Correspondence Address: DVA / PIONEER DIGITAL TECHNOLOGIES, SUITE 200, 2355 MAIN STREET, IRVINE, CA, 92614, US

(21) Appl. No.: 10/064,742

(22) Filed: Aug. 12, 2002

(51) Int. Cl. G06F 15/173; G09G 5/00

(52) U.S. Cl. 709/224; 345/736

(57) ABSTRACT

The remote retrieval and viewing of information from a set-top box is described, wherein a network is used to facilitate the querying of the internal state of a set-top box. In response, the set-top box returns its internal state information across the network to the requesting user. In one embodiment, a GUI is used wherein a user inputs a unique identifier for the set-top box. The unique identifier is used to locate the set-top box on the network and to instruct it as to which internal state information is needed. In another embodiment, a web browser is used to implement the GUI as a web page. The GUI includes at least an area for the input of the set-top box's unique identifier.

### COPYRIGHT STATEMENT

All of the material in this patent document is subject to copyright protection under the copyright laws of the United States and of other countries. Portions of the material in this patent document are also subject to protection under the maskwork registration laws of the United States and of other countries. The owner of the copyright and maskwork rights has no objection to the facsimile reproduction by anyone of the patent document or the patent disclosure, as it appears in the United States Patent and Trademark Office file or records, but otherwise reserves all copyright and maskwork rights whatsoever.

### BACKGROUND OF INVENTION

1. Field of the invention

The present invention relates generally to set-top boxes, and more particularly, to a method and apparatus which enables a user to remotely retrieve and view diagnostic information from a set-top box.

2. Background of the Invention

A set-top box is a device that is connected to a television set (TV) or is integrated into the TV and enables a user to enhance the functionality of the TV. Set-top boxes are used, for instance, to retrieve a cable signal, to retrieve a program guide, to control the recording and playback of certain television signals, to use the Internet, and to otherwise allow the user to have an enhanced experience when using the TV. Set-top boxes, as with all electrical devices, occasionally need maintenance and repair. Moreover, set-top boxes are devices that are part of an interconnected network, and as network devices their status must be monitored regularly in order to diagnose network issues and software bugs that occasionally occur.

Currently, to diagnose and view the details describing a problem either with the set-top box itself or with its network connection, a technician must go to the location of the set-top box and query the device for information necessary to diagnose the problem. Alternatively, a phone operator must instruct a person at the location of the set-top box to manually perform the queries and relay the information to the operator. The first technique is disadvantageous because it requires the time and expense associated with a driver physically going to a distant location to diagnose the problem, even if the problem might be solved without going to that location.

The second technique is disadvantageous because it requires the assistance of a middle-person, who has no technical knowledge of querying a set-top box, who does not own the set-top box, who might not be able to properly perform the queries needed to diagnose the problem, and who ordinarily does not need to know the procedure for diagnosing a set-top box. Before further discussing these drawbacks, an overview of set-top boxes is provided.

Set-Top Boxes

A set-top box is typically connected to a conventional TV and controlled by a hand-held remote control device. The set-top box provides a graphical user interface (GUI) by which a user can easily access both standard television programming and interactive content, using the conventional television set as an audio and visual output device. Interactive content includes, for instance, web pages, audio, and video, any of which may originate from the Internet. Some interactive data may be embodied in a markup language, such as Hypertext Mark-up Language (HTML) or extensible Markup Language (XML). The set-top box might utilize web browser software to allow the user to access and download interactive content.

FIG. 1 illustrates a system, which includes a set-top box 10 that is connected to a conventional TV 20 via a transmission line 30. TV signals are received by the set-top box 10 via transmission line 40, which may be connected to either an antenna or a cable television outlet. Set-top box 10 receives conventional AC power through a line 50. Set-top box 10 receives user input entered from a handheld remote control 60 over a wireless link 70. Wireless link 70 may be an infrared (IR) link, a radio frequency (RF) link, or any other suitable type of link.

A bi-directional data path 80 is provided to set-top box 10, through which set-top box 10 can access the Internet 91 via Intranet 90. Bi-directional data paths 80 and 81 typically comprise RF networks across which set-top box 10 is able to communicate with Internet 91 via Intranet 90. Set-top box 10 also includes an input area 95. Either input area 95, or remote control 60, or both contain functionality for querying the state of set-top box 10 in order to retrieve diagnostic information. When set-top box 10 is queried, a user is able to determine and diagnose problems and maintenance issues with set-top box 10.

FIG. 2 illustrates a block diagram of the internal components of set-top box 10. Note that FIG. 2 is intended to be a conceptual diagram and does not necessarily reflect the exact physical construction and interconnections of these components. Set-top box 10 includes processing and control circuitry 200, which controls the overall operation of the system. Coupled to the processing and control circuitry 200 are a TV tuner 210, a memory device 220, a communication device 230, a remote interface 240, and a diagnostic functionality block 250. TV tuner 210 receives the television signals on transmission line 260, which may originate from an antenna or a cable television outlet. Processing and control circuitry 200 provides audio and video output to TV set 20 via a line 270. Remote interface 240 receives signals from remote control 60 via wireless connection 70. Communication device 230 is used to transfer data between set-top box 10 and one or more remote processing systems, such as a web server 280, via a data path 290.

Processing and control circuitry 200 may include one or more of devices such as general-purpose microprocessors, digital signal processors (DSPs), application specific integrated circuits (ASICs), various types of signal conditioning circuitry, including analog-to-digital converters, digital-to-analog converters, input/output buffers, etc. Memory device 220 may include one or more physical memory devices, which may include volatile storage devices, non-volatile storage devices, or both. For example, memory 220 may include both random access memory (RAM), read-only memory (ROM), various forms of programmable and/or erasable ROM (e.g., PROM, EPOM, EEPROM, etc.), flash memory, or any combination of these devices.

Diagnostic functionality 250 (which may comprise a software process, hardware, or a combination of both) is configured to query one or more internal states of set-top box 10 and the status of its network connection in order to diagnose, detect, and display information relating to maintenance and repair issues. Diagnostic functionality 250 operates, for instance, by an input signal being presented by remote control 60 to remote interface 240 and then to diagnostic functionality 250 via processing and control circuitry 200. The input signal is used to instruct diagnostic functionality 250 as to which diagnostic states to query. The results of the query are presented as output on TV screen 20 via line 270. Alternatively, a direct interface (not shown) may be used to perform an analogous operation at diagnostic functionality 250.

Communication device 230 may be a conventional telephone (POTS) modem, an Integrated Services Digital Network (ISDN) adapter, a Digital Subscriber Line (xDSL) adapter, a cable television modem, or any other suitable data communication device. Note that in various other embodiments, other components may be added to the system, either as components of set-top box 10 or as peripheral devices. Such components might include, for example, a keyboard, a mass storage device, or a printer. Such components may be connected via a physical connection or by a wireless connection (e.g., a wireless keyboard).

Querying and Viewing Diagnostic Information

Currently, to diagnose the problem that requires the maintenance, repair, or intervention a cable technician must go to the location of the set-top box and query the device in order to view the information necessary to diagnose the problem.

Alternatively, a phone operator must instruct a person at the location of the set-top box to manually perform the queries and relay the information to the operator. For instance, a problem needing intervention could be as simple as parental control being activated on a channel, and the viewer not recognizing this state. The viewer would simply need to enter their parental control PIN to get out of this state, however, currently diagnosing this situation requires one of the two disadvantageous procedures described above.

Once the internal diagnostics of the box or its network state are understood, an action to fix the problem or intervene can take place. This includes, for instance, repairs or changes at the location of the set-top box, or signals sent to the set-top box from a remote location across a network. For example, if a box is experiencing macro-blocking of digital pictures (e.g., bad digital pictures), one would have to go to the location of the box to detect if the signal levels are low (i.e., it is a network problem) or if a lower level software problem is to blame.

Querying and viewing the internal diagnostics of the set-top box at the location of the box is disadvantageous because of the time and expense associated with a driver physically going to a distant location to diagnose the problem. This is especially true when the problem is solved simply with signals sent from a remote location, as is the case with macro-blocking or with a mistakenly installed PIN.

It is also disadvantageous to have a phone operator instruct the user of the box in querying and viewing its internal diagnostics because it requires the assistance of a middle-person, who has no technical knowledge of querying a set-top box, who does not own the set-top box, and who might not be able to properly perform the queries needed to diagnose the problem. Furthermore, it is undesirable to allow the user of the box to understand how to query the diagnostics of the box, since this is a function of the box provider, owner, or repair person.

### SUMMARY OF INVENTION

Embodiments of the present invention are directed toward the remote retrieval and viewing of diagnostic information from a set-top box. According to the present invention, a network is used to facilitate the querying of the diagnostics of a set-top box and its network connection. In response, the set-top box returns its diagnostic information across the network to the requesting user where they are viewed. The diagnostic information allows an operator to remotely diagnose problems and/or maintenance issues with the system, hardware, or network.

In one embodiment, a GUI is used wherein a user inputs a unique identifier for the set-top box. The unique identifier is used to locate the set-top box on the network and to instruct it as to which diagnostics are needed. In another embodiment, a web browser is used to implement the GUI as a web page, which may be formatted using HTML, XML, or any other suitable web-based technology. The GUI includes at least an area for the input of the set-top box's unique identifier as an IP address, a MAC address, or a set-top box serial number. Diagnostic information includes, for instance, a system summary, an identity, feature authorizations, versions, network configurations, tuning information, RF network information, MPEG information, hardware information, memory, system information, channel information, program guide events information, broadcast file system (BFS) information, pay-per-view (PPV) information, entitlement management message (EMM) status, passthru messages, last reset state information, media on demand (MOD) information, MOD purchases, and MOD events.

In another embodiment, the network structure where the invention takes place includes a first network layer having an application server (which may be a general purpose computer) connected to multiple set-top boxes in an intranet and a second network layer where a second server is connected to the application server. The second network layer includes, for instance, the world wide web or an internal intranet.

### BRIEF DESCRIPTION OF DRAWINGS

The invention will be more fully understood by reference to the following drawings, which are for illustrative purposes only:

FIG. 1 is a diagram that illustrates a system that includes a set-top box.

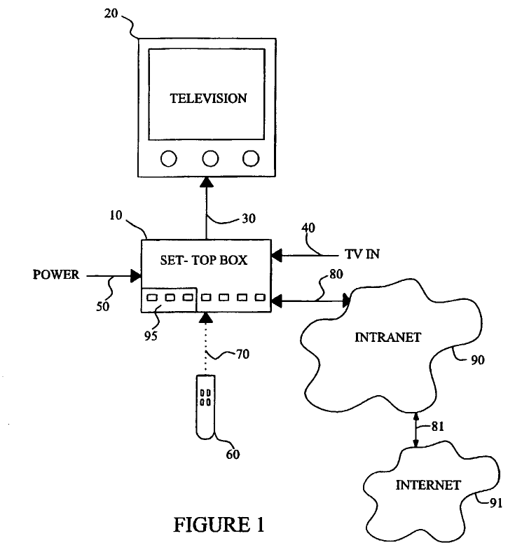

FIG. 2 is a functional block diagram of the internal components of a set-top box.

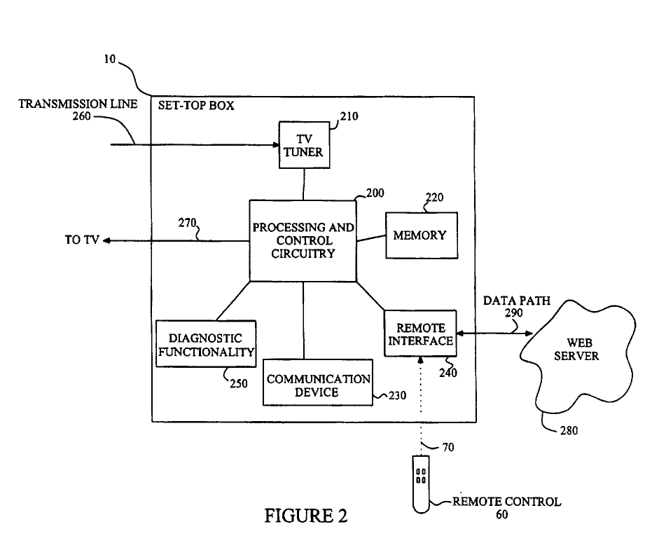

FIG. 3 is a flowchart showing the operation of one embodiment of the present invention.

FIG. 4 is a flowchart showing the operation of another embodiment of the present invention.

FIG. 5 is a functional diagram showing the structure of a network where an embodiment of the present invention can be implemented.

FIG. 6 is a flowchart showing an embodiment of the present invention that uses web pages.

FIG. 7 is a user interface screen in accordance with one embodiment of the present invention.

### DETAILED DESCRIPTION

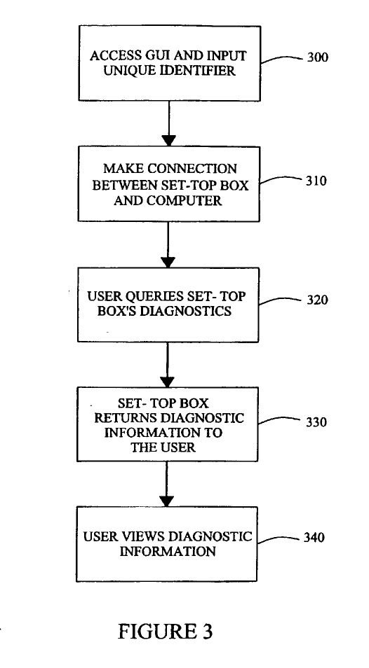

Embodiments of the present invention are directed to the remote retrieval and viewing of information from a set-top box. FIG. 3 is a flowchart showing the remote retrieval and viewing of information from a set-top box according to one embodiment. At block 300, a user (a customer service representative or other technician, for instance) accesses a GUI and inputs a unique identifier for the set-top box. At block 310, a connection is made over a network between a computer and the set-top box. This may occur, for instance, by an RF network that is established between the set-top and a local intranet, wherein data is transferred over the RF network from the set-top to a computer connected to the intranet and vice-versa. In another embodiment, a local or global computer network (e.g., the Internet) is connected to the intranet and the data exchange may occur between a computer connected to the Internet and the set-top box via the RF network.

At block 320, the user queries the diagnostics of the set-top box. At block 330, the set-top box returns its diagnostic information to the user. At block 340, the user views the set to box diagnostic information. In one embodiment, when the user views the diagnostic information it is in the same form it is in when it is viewed directly at the location of the set-top box.

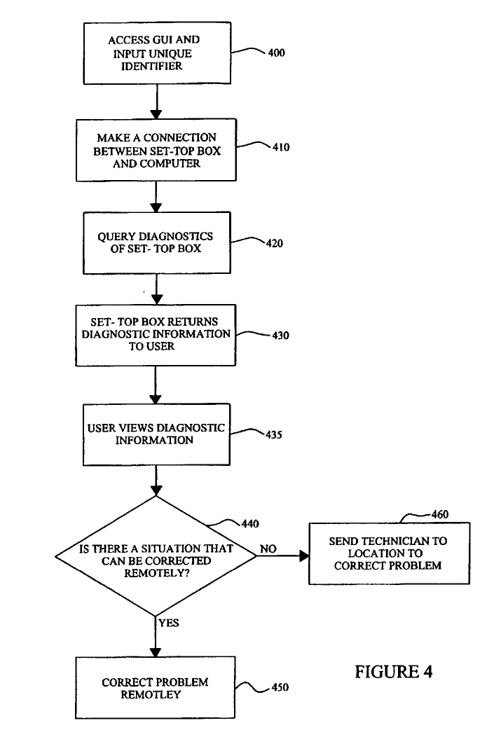

FIG. 4 is a flowchart showing how an embodiment of the present invention can be used to facilitate the service, repair, or intervention into a situation where a set-top box needs to be accessed. At block 400, a user (a customer service representative or other technician, for instance) accesses a GUI and inputs a unique identifier for the set-top box. At block 410, a connection is made between the user's computer and the set-top box. At block 420, the user queries for the diagnostics of the set-top box. At block 430, the set-top box returns its diagnostic information to the user. At block 435 the user views the diagnostic information. At block 440, the user determines whether the diagnostic information reveals a state that can be corrected remotely. If so, at block 450 the user corrects the problem remotely. Otherwise, at block 460, a technician is sent to the location of the box to address the issue.

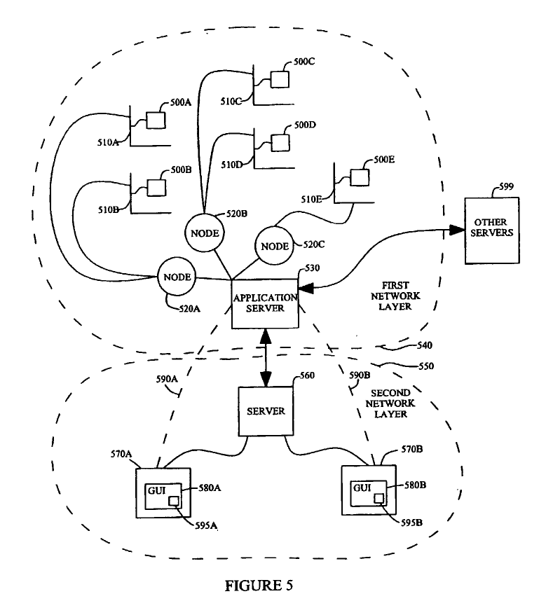

FIG. 5 is a block diagram showing the structure of an interconnected network that is used to implement the present invention. One or more set-top boxes 500a-500e are connected to as cable outlet in the wall of their house 510a-510e, which in turn is connected to a node at the street 520a-c. Note that multiple boxes might be connected to the same node. All of the nodes at the street 520a-c in turn are connected to an application server 530. Application server may be a general purpose computer or other suitable server. This forms a first network layer 540 that is traditionally considered an intranet.

The diagram of first network layer 540 is for purposes of example only. One skilled in the art will recognize that nodes 520a-c may be RF nodes or some other suitable node. Also between nodes 520a-c and application server 530 there may be modulators, demodulators, routers, and switches (not shown) depending on the network topology. Moreover, application server 530 may have one or more connections to other servers 599, wherein other servers 599 may share data with application server 530 that enables it to communicate with a specific set-top box 500a-e.

A second network layer 550, which comprises an Internet or another Intranet is connected to first network layer 540. Second network layer 550 includes an optional server 560 connected to the application server 530, which acts as an intermediary for one or more client computers 570a and 570b to access the set-top boxes 500 by using a GUI 580a and 580b. In the absence of the optional server 560, the clients 570 connect directly to network layer 540 via application server 530 as shown by dotted lines 590a and 590b. GUIs 580a and 580b include input areas 595a and 595b that at least provide for the specification of a unique identifier that allows the client to access any particular set-top box on the network.

GUI

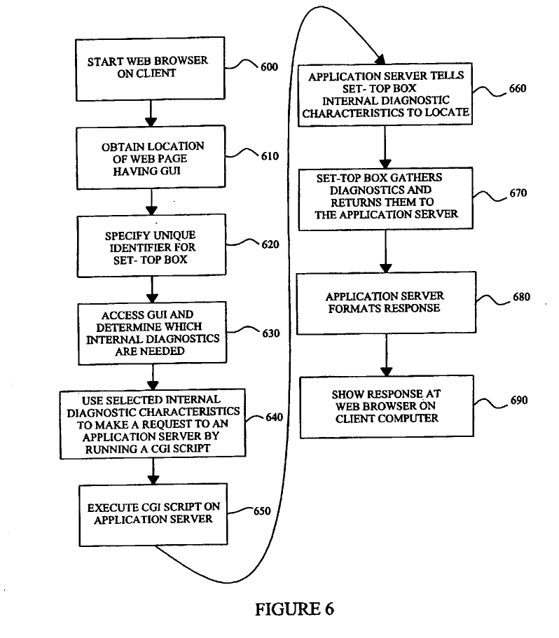

In one embodiment, the GUI used in conjunction with the present invention comprises a web page, which may be in HTML, XML, or in another suitable format. This embodiment of the present invention is shown with respect to FIG. 6. At block 600 of FIG. 6, a user starts a web browser capable of displaying a web page on a client computer. At block 610, the location of the web page is obtained where the GUI is located. This is accomplished, for instance, by specifying a unique uniform resource locator (URL) for the web page. At block 620, the user specifies a unique identifier for the set-top box, such as an IP address, a MAC address, or a serial number.

At block 630, the user accesses the GUI and determines which internal diagnostic characteristics are needed from the set-top box. At block 640, the browser uses the selected internal diagnostic characteristics and makes a request to an application server by running a common gateway interface (CGI) script. At block 650, the CGI script is executed on the application server. At block 660, the application server tells the set-top box which internal diagnostic characteristics to locate depending on the contents of the executing CGI script. At block 670, the set-top box gathers the requested internal diagnostic characteristics and returns them to the application server. At block 680, the application server formats the set-top box's response into HTML, XML, or another suitable format and at block 690, the response is shown at the web browser of the user's client computer.

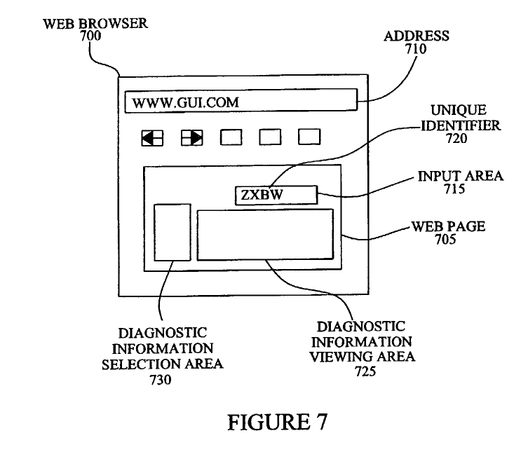

An example of a GUI that is used in one embodiment of the present invention is shown in FIG. 7. Web browser 700, displays a web page 705, when directed to the appropriate address 710. Web page includes an input area 715 configured to receive a unique identifier 720 associated with a set-top box. Unique identifier 720 is used to locate the desired set-top box on a network. GUI also includes a diagnostic information selection area 730 and a diagnostic information viewing area 725.

Diagnostic information selection area 730 includes for instance, links to other addresses that when selected will access other web pages showing various diagnostic information for the set-top box. These web pages may be displayed, for instance in diagnostic information viewing area 725 and may also optionally be in a format to that which is displayed directly at the location of the set-top box.

Depending upon the application, diagnostic information selection area 730 includes links relating to a system summary, an identity, a feature authorization, versions, network configuration, tuning, RF network, MPEG information, hardware information, memory, system information, channel application information, program guide events, BFS, PPV and authorization information, PPV past NVRAM, PPV pending NVRAM, PPV event, EMM status, passthru messages, and last reset state information. These links are described in more detail below.

Diagnostic Information

In one embodiment, the diagnostic information shown in diagnostic information selection area 730 has various types of diagnostic information organized into categories. Table 1 shows each of the categories and gives an overview of what each category is used for.

TABLE 1

| Category | Use |
|---|---|
| System | Summarizes important information from other |
| Summary | diagnostics screens |
| Identity | Identifies the set-top box on the network including |
| | the IP and MAC addresses |
| Feature | System features for which this set-top box is |
| Authorization | authorized |
| Versions | Current software and operating system versions |
| | residing on the set-top. |
| Network | Set-top network configuration information |
| Configuration | |
| Tuning | This screen provides tuning information and allows |
| | the user to tune to specific channels |
| RF Network | Information about the RF network, the Forward Data |
| | Channel (FDC), Reverse Data Channel (RDC), QAM, |
| | etc. |
| MPEG | PID information and other details about the MPEG |
| Information | stream for the current digital channel |
| Hardware | Results of hardware testing called the power-on self |
| Information | test (POST) of the set-top box |
| Memory | Summary of total and available set-top box memory |
| System | Information about the total number of services, |
| Information | channels, channel types, etc. |
| Channel | Application programming interface (API) version |
| Application | number of the channel application API and the date |
| Information | and time when it was last launched |
| Program Guide | Information about interactive program guide (IPG) |
| Events | events, such as when the IPG data was loaded and |
| | how many events are included in the loaded IPG data |
| BFS | Various diagnostics about the BFS, including the total |
| | bytes of data read from in-band and out-of-band |
| | carousels; information about when certain common |
| | files were most recently read, if any errors occurred |
| | when they were read; and some performance |
| | information useful for fine-tuning the BFS data |
| | carousel rates |
| PPV and | Number of PPV purchases, PPV credits, and |
| Authorization | information about poll requests |
| Information | |
| PPV Past | lnformation about past PPV purchases |
| NVRAM PPV | lnformation about pending PPV purchases |
| Pending NVRAM | |
| PPV Event | Information about a currently tuned PPV event or the |
| | last tuned-to PPV event |
| EMM Status | Information about the entitlement management |
| | messages (EMMs) |
| Passthru | Information about Passthru messages |
| Messages | |
| Last Reset State | Information about the last time a set-top box was |
| Info | reset |

System Summary

If a user selects the system summary link from diagnostic information selection area 730, a screen is shown that allows an operator to quickly check the status of the system. In one embodiment, the screen includes the information shown in Table 2.

TABLE 2

| Field | Shows |
|---|---|
| Service | Whether the system information and BFS information was |
| State | received (Ready) or not (Default Analog) |
| Tuner | Whether the signal was found and the modulation mode of |
| State | the signal. For analog, this field shows WaitingSync, then |
| | FoundSync. For digital channels, this field firstshows |
| | WaitingQAM and then FoundQAM. The modulation mode can |
| | be analog, QAM 64, QAM 128, QAM 256, Not Tuned, or Error |
| | FoundQAM Sync acquired, enabling digital TV viewing |
| | FoundSync Sync acquired, enabling analog TV viewing Ready |
| | Set-top and tuner in idle mode, not in use Suspending |
| | Deactivation request is made, waiting for resources to |
| | respond WaitingQAMWaiting to complete QAM tuning, |
| | enabling digital TV viewing WaitingSync Waiting to acquire |
| | sync, enabling analog TV viewing |
| RF | Set-top's MAC address of RF (cable) port |
| MAC | |
| Addr | |
| RF IP | Set-top's IP address of RF (cable) port as assigned by the |
| Addr | DNCS. You can ping this address from the DNCS to see if the |
| | set-top is active on the network. If the address is 0, the set- |
| | top could not get the address from the headend. If the user- |
| | to-network configuration (U-N Config) field shows Broadcast, |
| | the address is 0 because the set-top could not respond to |
| | the headend. If the set-top loses its address the screen does |
| | not update this field to 0 until you reboot the set-top. In this |
| | case it stores the PPV purchases up to the credit limit until it |
| | can send them to the headend |
| Hub ID | The ID of the hub this set-top is connected to. The DNCS can |
| | support multiple hubs. Each hub may have its own channel |
| | lineup |
| Tuner | Frequency that the unit is currently tuned to and the signal |
| | level of the channel. The field shows the frequency in MHz, and |
| | the signal level and modulationmode as analog, QAM-64, QAM- |
| | 128, or QAM-256. An acceptable range is between −16 dBmV |
| | to +15 dBmV. The recommended operating range |
| | is between 10 dBmV and +10 dBmV. If the digital power level |
| | is out of range, it displays as > Range (higher than +15 |
| | dBmV) or < Range (lower than −15 dBmV). The set-top does |
| | not measure power levels when it tunes to analog channels, |
| | and thus does not display this information for analog |
| | channels |
| FDC | Frequency and signal level of the Forward Data Channel |
| | (FDC). An acceptable range is between −16 dBmV and +15 |
| | dBmV. The recommended operating range is between −10 |
| | dBmV and +10 dBmV |
| RDC | Frequency and signal level of the transmitter for the Reverse |
| | Data Channel (RDC). An acceptable range is between +25 |
| | dBmV and +55 dBmV. A recommended operating range is |
| | between +27 dBmV and +53 dBmV, depending on the |
| | equipment location within the cable plant |
| QAM | Average signal-to-noise (SNR) ratio of QAM signal, indicating |
| average | the quality of the signal. 25 to 35 is adequate |
| SNR | |
| Tuner | Bit error rate (BER) average since last tune. This is the |
| BER | number of erroneous bits divided by the total number of bits |
| average | transmitted over the same period. This shows the quality of |
| | digital channels. This field is not applicable for analog |
| | channels. Nominal values are < 1 × 10 − 9. Typical is |
| | 1 × 10 − 6 + 0 to 1 × 10 − 7. Anything worse than 1 × 10 − 3 |
| | should be looked at. |
| Video | Number identifying the video packet identifier (PID) for this |
| PID | channel. Not applicable for analog channels |
| Audio | Number identifying the audio PID for this channel. Not |
| PID | applicable for analog channels |
| SI | Whether system information was received (yes or no) and |
| | when it was last generated (date). The system information is |
| | a single tuning table which maps thesource IDs to |
| | frequencies and PIDs. The DNCS generates this information, |
| | broadcasts it, and the set-top listens for it. If the date is |
| | incorrect, the set-top may have been unable to get a system |
| | information update, or the information may have been |
| | changed on the DNCS; this causes the lineup to be incorrect |
| BFS | Whether the BFS directory was located on the network and its |
| | directory structure cached into set-top memory. This |
| | typically happens at reset once or twice every hour. If the BFS |
| | read date is older than half an hour, the set-top may have a |
| | stale BFS directory. In this case, reboot the set-top to obtain |
| | files |
| U-N | State of the U-N Config, indicating whether there is two-way |
| Config | communication between the set-top and headend Unknown |
| | Error condition Not connected Set-top cannot hear the |
| | headend or respond (the cable plant is Down or the cable is |
| | not connected to the wall) Interactive Two-way |
| | communication, set-top can hear and respond to Headend |
| | Broadcast Set-top can listen to headend but cannot |
| | respondNote: broadcast can be a normal state in a network |
| | that is not two-way capable and does not provide IPPV. |

Identity Information

If a user selects the identity information link from diagnostic information selection area 730, a screen is shown that allows an operator to identify the set-top on the network. In one embodiment, the screen includes the information shown in Table 3.

TABLE 3

| Field | Shows |
|---|---|
| Ethernet IP | Provides the set-top's ethernet IP address. This field |
| Address | shows 10.1.1.1 by factory default if the address is not |
| | changed by the DNCS. |
| RF IP Address | Provides the set-top's IP address of RF (cable) port as |
| | assigned by the DNCS. You can ping this address to see |
| | if the set-top is active on thenetwork. If the address is |
| | 0, the set-top could not get the address from the |
| | headend. If the U-N Config field shows broadcast, the |
| | address is 0 because the set-top could not respond to |
| | the headend. If the set-top loses its address the screen |
| | does not update this field to 0 until you reboot the set- |
| | top. In that case it stores the PPV purchases up to the |
| | credit limit until it can send them to the headend |
| Ethernet MAC | Provides the set-top's ethernet MAC address which can |
| Address | be used for cable-modem type applications |
| RF MAC | Provides the set-top's MAC address of RF (cable) port. |
| Address | This is the primary identifier that headend operators |
| | use to identify the set-top on the network; for |
| | example, when they send addressed messages to |
| | individual set-tops via the DNCS, system administrator, |
| | or billing system. Each set-top has a unique RF MAC |
| | address that never changes |
| Secure Micro | Provides the MAC address of the secure micro chip in |
| | the set-top |
| Smart Card | Provides the MAC address of the smart card in the set- |
| | top (if installed) |
| Hub ID | Provides the ID of the hub this set-top is connected to. |
| | The DNCS can support multiple hubs. Each hub may |
| | have its own channel lineup |
| Region | Provides the region associated with the channel lineup |
| | region/hub tree |
| Configuration | Provides the region associated with the feature |
| Region | configuration region/hub tree |

Feature Authorization Information

If a user selects the feature authorization information link from diagnostic information selection area 730, a screen is shown that allows an operator to test the set-top box for authorization features from the service provider. This information displays on the feature authorization screen. For each feature, this screen shows YES, NO, or YES (NO CHECK).

When a feature shows YES, it indicates that the set-top has been authorized at the headend for the package representing this feature. You can enable certain features such as the program guide or IPPV per set-top via the billing system, authorizing certain packages for each subscriber. When a feature shows YES (NO CHECK), it indicates that the set-top is authorized for this feature. This setting indicates that the system is configured to allow all set-tops to have free access to this feature without checking for specific authorization. When a feature shows NO, it indicates that the set-top is not authorized for this package, so the feature is unavailable on this set-top. In one embodiment, the feature authorization screen includes the information shown in Table 4.

[t5]

TABLE 4

| Field | Shows |
|---|---|
| Guide | Whether the set-top is enabled to display program guide |
| | and channel banner information |
| VCR | Whether the set-top is enabled to use a VCR controller |
| Controller | device |
| Active Box | Whether the set-top is active or not. Cable operators can |
| | turn off cable features for a set-top in the event of |
| | subscriber non-payment. This puts the set-top in brick |
| | mode; it does not offer any authorized features |
| IPPV | Whether the set-top is enabled to use IPPV |
| Force PIN | Whether the set-top is enabled for force PIN. When a set- |
| | top has a force PIN, the subscriber cannot disable the |
| | purchase PIN and must use it to make purchases |
| Reading | Whether the set-top is reading from NVRAM. When a set- |
| From | top is reading from NVRAM, it is unable to get the |
| NVRAM | information from the BFS and gets settings from the last |
| | file stored in NVRAM. When a set-top is not reading from |
| | NVRAM, it is reading from the BFS and is using the latest |
| | settings |

Version Information

If a user selects the version information link from diagnostic information selection area 730, a screen is shown that allows an operator to check the set-top's current software versions, including versions for the service provider's software and the operating system software (e.g., PowerTV). This information is provided on the versions screen. One embodiment of the information provided at the versions screen is shown in Table 5.

[t3]

TABLE 5

| Field | Shows |
|---|---|
| OS Version | Version number of the operating system currently |
| | running on this set-top |
| Resident | Name and version number of system software, the |
| Application | resident application |
| Version | |
| OS Date | Date and time when the OS version was built |
| Resident | Date and time when system software was built |
| Application | |
| Date | |
| Secure Micro | Version number of Secure Micro devices in mask ROM |
| | and non-volatile memory |
| Smart Card | Version number of smart card device in mask ROM and |
| | non-volatile memory (if smart card is installed). This |
| | field shows <None> if the Smart Card feature is |
| | unavailable |
| Last Cold Boot | Date and time when the set-top was last plugged in to |
| | power up the set-top. A dash (-) indicates that system |
| | clock was unavailable when the set-top booted |
| Last Warm | Date and time when the set-top was last turned on |
| Boot | using the power button on the set-top front panel or |
| | the CBL button on the remote. A dash (-) indicates that |
| | the system clock was unavailable when the set-top |
| | booted |
| Current Time | Current date and time. If this field shows xx/xx/xxxx, |
| | the set-top has not successfully connected to the |
| | headend network to receive a time synchronization |
| | message |

Network Configuration Information

If a user selects the network configuration information link from diagnostic information selection area 730, a screen is shown that allows an operator to check how the set-top box communicates to the network. This information displays on the network configuration screen. One embodiment of the information provided at the network configuration screen is shown in Table 6.

[t6]

TABLE 6

| Field | Shows |
|---|---|
| Ethernet | Provides the set-top's ethernet IP address. This field shows |
| IP | 10.1.1.1 by factory default if the address is not changed by |
| Address | the DNCS. |
| RF IP | Provides the set-top's IP address of RF (cable) port as |
| Address | assigned by the DNCS. You can ping this address to see if |
| | the set-top is alive. If theaddress is 0, the set-top could not |
| | get the address from the headend. If U-N Config shows |
| | broadcast, the address is 0 because the set-top could not |
| | respond to the headend. If the set-top loses its address the |
| | screen does not update this field to 0 until you reboot the |
| | set-top. In that case it stores the PPV purchases up to the |
| | credit limit until it can send them to the headend |
| Primary | Provides the set-top's IP address for IP networking. Usually |
| IP | this is the same as the RF IP address |
| Address | |
| Ethernet | Provides the mask used for ethernet IP address |
| Mask | |
| RF Mask | Provides the mask used for RF IP address |
| Primary | Provides the mask used for primary address. Usually this |
| Mask | field shows the same information as the RF Mask field |
| DAVIC | Provides the current DAVIC connection status. Connected 2- |
| State | way is the usual status. There are 17 other states (Booting, |
| | Searching Channels, Provisioning, Unauthorized, etc.), many |
| | of which are not seen because they happen very quickly. |

If a user selects the tuning information link from diagnostic information selection area 730, a screen is shown that allows an operator to see information about the channel that the set-top is currently tuned to. This information includes the frequency and the modulation mode. The tuning screen also enables tuning to channels, frequencies, and source IDs. In one embodiment, the tuning information screen shows the following information for the currently tuned channel shown in Table 7.

[t7]

TABLE 7

| Field | Shows |
|---|---|
| Display | Shows the display channel number (DCN), which is the |
| Channel | number assigned in the channel lineup at the headend; |
| | viewers use this number to tune |
| EIA | Channel number according to Electronic Industries |
| Channel | Association (EIA) standards. This only exists for analog |
| | channels |
| Source ID | Source ID of the displayed channel as entered in the DNCS |
| | source provisioning |
| Tune to | Center frequency of the analog or digital channel to which |
| Frequency | the set-top is currently tuned (Not Tuned means that |
| | parental control is activated) |
| Tuning | Tuning mode of the channel to which the set-top is |
| Mode | currently tuned. This can be analog, QAM-64, QAM-128, |
| | or QAM-256 |
| Program | MPEG program that the set-top is currently tuned to |
| Number | (digital only) |
| Video PID | Number identifying the video PID for this channel. Not |
| | applicable for analog channels |
| Audio PID | Number identifying the audio PID for this channel. Not |
| | applicable for analog channels |
| AC-3 | Whether the stream contains Dolby AC-3 audio |
| | compression information. Not available for analog |
| | channels |
| Channel | The state of the channel: Authorized - Available channel |
| Status | on this set-top Clear to air - Non-encrypted channel |
| | Subscription - Encrypted channel authorized by |
| | subscription Free Preview - Channel authorized due to |
| | preview window on current PPV event Purchased Event — |
| | Authorized (purchased) PPV event Not Tuned - Tuner is |
| | not tuned (parental control may be enabled) |

RF Network Information

If a user selects the RF network information link from diagnostic information selection area 730, a screen is shown that allows an operator to see tuner frequency information, FDC frequency and signal level information, and RDC frequency and signal level information. In one embodiment, the RF network information screen shows the following information shown in Table 8.

[t8]

TABLE 8

| Field | Shows |
|---|---|
| Tuner | Center frequency for the channel the set-top is |
| | currently tuned to and the power level of the signal. |
| | For example, the center frequency is 63 if the |
| | frequency bandwidth is from 60 to 66. An |
| | acceptable power level is −16 dBmV to +15 dBmV. |
| | The recommended operating range is between −10 dBmV |
| | and +10 dBmV. If the level is out of range, |
| | this field shows <Range or> Range. The set-top |
| | does not measure power levels when it tunes to |
| | analog channels, and thus does not display this |
| | information for analog channels (Not Tuned means |
| | that parental control is activated) |
| FDC | Frequency and signal level of the out-of-band FDC |
| | channel. An acceptable range is between −16 dBmV |
| | and +15 dBmV. The recommended operating range |
| | is between −10 dBmV and +10 dBmV |
| RDC | Frequency and signal level of the set-top's |
| | transmitter of the out-of-band RDC channel. An |
| | acceptable range is between +25 dBmV and +55 dBmV. |
| | A recommended operating range is between |
| | +27 dBmV and +53 dBmV, depending on the |
| | equipment location within the cable plant |
| Tuning Mode | Tuning mode of the channel the set-top is currently |
| | tuned to. This can be analog, QAM-64, QAM-128, |
| | QAM-256, N/A, or Not Tuned if parental control is |
| | enabled |
| QAM | Corrected and uncorrected errors in blocks and the |
| Corr/Uncorr/ | total number of seconds during which the errors |
| Sec | occurred. This shows the quality of the digital signal |
| | and can be used to calculate the BER |
| Tuner BER | BER average since last tune. This is the number of |
| average | erroneous bits divided by the total number of bits |
| | transmitted over the same period. This shows the |
| | quality of digital channels. This field is not |
| | applicable for analog channels. Nominal values are < |
| | 1 × 10 − 9. Typical is 1 × 10 − 6 to 1 × 10 − 7. |
| | Anything worse than 1 × 10 − 3 must belooked at |
| QAM Main | Normalized main tap coefficient used for calibrating |
| Tap | data path delay or frequency response |
| QAM average | Average signal-to-noise ratio (SNR) of QAM signal, |
| SNR | indicating the quality of the signal. 25 to 35 is |
| | adequate, higher is better. Not applicable for analog |
| | channels |
| FDC corr/ | Corrected bytes and uncorrected blocks of the out- |
| uncorr/bytes | of-band FDC channel and the total number of bytes |
| | received |
| FDC BER | Average BER for the FDC channel. This is the number |
| average | of erroneous bits divided by the total number of bits |
| | transmitted over the same period |
| RDC Range | Amount of time it takes to send a packet from the |
| Delay | set-top to the headend |
| RDC | Number of RDC retransmissions, indicating that the |
| retransmissions | set-top has detected that the headend did not |
| | respond to a message and therefore the set-top |
| | retransmitted the message. The set-top can check |
| | downstream QAM and the FDC path, but it cannot |
| | check if the headend received the correct message in |
| | the reverse path. It can only detect that the headend |
| | did not respond as expected |
| Return Path | Average time (in milliseconds) that it takes to get a |
| | TCP/IP “ping” message back from the headend, plus |
| | a count of the number of packets lost and sent. If |
| | this field shows an error number, check the |
| | operating system documentation or a UNIX manual. |
| | The errors are standard IP networking messages. If |
| | this field shows ERROR: IP address not configured, |
| | the operator did not set the IP address of the device |
| | at the headend that needs to be pinged. The set- |
| | topdoes not ping any device when this message |
| | shows |

MPEG Information

If a user selects the MPEG information link from diagnostic information selection area 730, a screen is shown that allows an operator to check information about the current MPEG. This information is only available for digital channels. In one embodiment, the MPEG information screen shows the information shown in Table 9.

[t9]

TABLE 9

| Field | Shows |
|---|---|
| Video PID | Number identifying the video PID for the MPEG stream |
| Audio PID | Number identifying the audio PID for the MPEG stream |
| PMT PID | PID number of the Program Map Table (PMT) |
| PCR PID | PID number for the Program Clock Reference (PCR). |
| | PCR is used to synchronize the encoder/transmitter |
| | and the decoder/receiver, and is transmitted in the |
| | transport stream periodically |
| Discontinuity | Sum of audio and video PID discontinuities detected on |
| Count | the MPEG stream; 0 is ideal, smaller is better |
| PCR Lock | Status of the PCR lock |
| Status | |
| Last PTS | Presentation time stamp (PTS) received. PTS is used to |
| | synchronize the encoder/transmitter and the |
| | decoder/receiver (similar to PCR) |
| PEI | Packet Error Indication counter indicating the number |
| | of errors detected in the MPEG stream before reaching |
| | the BIP |
| PER | Pipeline Error counter indicating the number of errors |
| | reported by the MPEG decoding chip |
| SER | Severe Error counter indicating the number of severe |
| | errors reported by the MPEG decoding chip |
| RST | Reset counter indicating the number of times the |
| | software driver restarted the MPEG decoding process |

Tuning Information

If a user selects the tuning information link from diagnostic information selection area 730, a screen is shown that provides tuning information about the current channel on the tuning information screen. In one embodiment, the tuning information screen shows the information shown in Table 10.

[t10]

TABLE 10

| Field | Shows |
|---|---|
| AppID | Number identifying the application which last controlled |
| | theTuner |
| Priority | Whether the last tuning request was primary or secondary |
| Request | The type of the last tuning request (such as source ID, |
| Type | frequency, or EIA) |
| State | The current state of the TV tuning resource: Active Resource |
| | is active Denied Resource was denied Notified Resource was |
| | asked to suspend but has not yet responded Processing |
| | Resource is moving between suspended and active states |
| | Suspended Resource is currently suspended WaitingPAT Set- |
| | top is locating MPEG program information, phase 1 |
| | WaitingPMT Set-top is locating MPEG program information, |
| | phase 2 |
| Tuner | Whether the signal was found. For analog, this field shows |
| State | WaitingSync, then FoundSync. For digital, this field first |
| | shows WaitingQAM and then foundQAM. FoundQAM Sync |
| | acquired, enabling digital TV viewing FoundSync Sync |
| | acquired, enabling analog TV viewing Ready Set-top and |
| | tuner not in use Suspending Deactivation request is made, |
| | waiting for resources to respond WaitingQAM Waiting to |
| | complete QAM tuning, enabling digital TV viewing |
| | WaitingSync Waiting to acquire sync, enabling analog TV |
| | viewing |
| SAP | Whether Secondary Audio Programming (SAP) is present on |
| Present | this channel |
| Stereo | Whether stereo audio is present on this channel |
| Present | |
| HubID | Number identifying the hub this set-top is connected to |
| Channel | Type of channel plan (HRC, IRC, or standard) |
| Plan | |
| PMT | Number of elements in the program map table |
| PID | PID number of the video PID and the state. This field only |
| number | shows information for digital channels |
| (video) | |
| PID | PID number of the audio PID, the state, and the available |
| number | languages. The bullet indicates which language is currently |
| (audio) | selected. This field only shows information for digital |
| | channels |

Hardware Information

If a user selects the hardware information link from diagnostic information selection area 730, a screen is shown that includes test information for the set-top hardware. When the set-top starts up, various hardware components are tested. This test is called the POST. The results of the testing are shown in the hardware information screen. In one embodiment, the following information shown in Table 111 is viewable in the hardware information screen.

[t11]

TABLE 11

| Field | Shows |
|---|---|
| MAC | Whether the Media Access Controller (MAC) passed the |
| | test |
| TVP | Whether TVP passed the test |
| BCM | Whether the Broadcom (BCM) QAM demodulator and |
| | Forward Error Correction (FEC) chip passed the test |
| BGATE | Whether BGATE passed the test |
| BTSC | Whether the Broadcast Television Systems Committee |
| | (BTSC) audio circuitry passed the test |
| AC-3 | Whether the multi-channel audio compression (AC-3) |
| | chip passed the test |
| RAM | Whether the RAM passed the test |
| I2C | Whether the Inter-IC control bus interface (I2C) passed |
| | the test |
| NVM | Whether the non-volatile memory passed the test |
| ROM | Whether the ROM checksum passed the test |
| Checksum | |
| Flash | Whether the flash checksum passed the test |
| Checksum | |
| Eagle | Whether the Eagle DRAM passed the test |
| DRAM | |
| Front Panel | Whether the front panel passed the test |
| RF Modem | Whether the RF modem passed the test |
| Ethernet | Whether the Ethernet passed the test. This field shows |
| | N/A if this set-top does not have the ethernet option |
| | available |
| SCSI | Whether the SCSI card passed the test |
| UARTs | Whether the Universal/Asynchronous Receiver |
| | Transmitters (UARTs) passed the test |
| SPI | Whether the serial/parallel interface passed the test |
| VCXO | Whether the Voltage Controlled Crystal Oscillator port |
| | (VCXO) passed the test |
| Hardware | Number indicating the hardware revision. You can use this |
| Rev | number to compare multiple set-tops if some work and |
| | others do not. Confirm this number with the DNCS |
| | database |
| MAC | Version of the MAC |
| Version | |
| BIP Version | BIP version |
| TVP | TVP version |
| Version | |
| AC-3 | Version of the AC-3 |
| Version | |
| BCM | Version of the BCM |
| Version | |
| BGATE | Version of the BGATE |
| Version | |

Memory Information

If a user selects the memory information link from diagnostic information selection area 730, a screen is shown that includes information about the set-top's memory. Table 12 shows the information presented at this screen according to one embodiment of the present invention.

[t12]

TABLE 12

| Field | Shows |
|---|---|
| Total System | Set-top's total RAM available for use in bytes |
| RAM | |
| Free | Set-top's current free system RAM in bytes |
| Largest | Set-top's current largest contiguous amount of free |
| | system RAM |
| Lowest | Set-top's lowest amount of free system RAM recorded |
| | to date since the last reboot |
| When | Date, time, and channel watched when lowest recorded |
| | system RAM occurred |
| Total Video | Set-top's total video RAM in bytes |
| RAM | |
| Free | Set-top's free video RAM in bytes |
| Largest | Set-top's largest contiguous amount of free video RAM |
| | to date |
| Lowest | Set-top's lowest amount of video RAM recorded to date |
| When | Date, time and channel watched when the lowest |
| | amount of video RAM was recorded |
| Free Events | The number of free operating system event structures |
| | available application use |

System Information

If a user selects the system information link from diagnostic information selection area 730, a screen is shown that includes information such as the total number of services in the channel lineup, the total number of channels allocated, and how many of those channels are designated as surfable, video, PPV, or split. Table 13 shows the information presented at this screen according to one embodiment of the present invention.

[t13]

TABLE 13

| Field | Shows |
|---|---|
| AspMgr | Status of the Asp manager (OK, unavailable, or counting |
| Status | when it is analyzing the channel lineup information) |
| Total | Number indicating the total number of services |
| Services | |
| Total | Number indicating the total number of channels |
| Channels | |
| Surfable | Number indicating the total number of surfable channels |
| Video | Number indicating the total number of video channels |
| PPV | Number indicating the total number of PPV channels |
| Split | Number indicating the total number of split channels |
| Last 5 | Date, time, error codes, and handling parameters of the |
| anomalies | last five anomalies. If the errors occur multiple times this |
| | is indicated, for example x2. An anomaly is something |
| | unexpected, an exception to the rule. After a reboot only |
| | the most recent two anomalies appear |

Channel Application Information

If a user selects the channel application information link from diagnostic information selection area 730, a screen is shown that includes information about the most recently launched external channel application. This is an application of which the code is downloaded from the BFS instead of being resident in the set-top and launched from ROM, such as Music Choice or PPV. In one embodiment, the information shown at the channel application screen is shown in Table 14.

[t14]

TABLE 14

| IPG | |
|---|---|
| information | Example |
| Launched | Date and time when the external application was last |
| | attempted to be loaded from the BFS |
| Last Error | Error codes or other indications given by the application |
| | that prevented the application from launching on this |
| | platform. The most common messages are listed below. |
| | File Not Found Application URL indicated in the service |
| | table could not be located on the BFS Incompatible |
| | Version Number Version of the external application on |
| | the BFS is too new or too old to be compatible with this |
| | version Incompatible Platform Incorrect type of |
| | application for this platform. Most External applications |
| | are compatible across all configurations, but in certain |
| | special cases there are specific versions of the |
| | application |
| Last Error At | Date and time when the last error occurred |
| URL | The filename and/or path name indicating the Uniform |
| | Resource Locator (URL) on the BFS where the application |
| | was launched |
| API Ver | Version number of the current Channel App API. |

Program Guide Event Information

If a user selects the program guide event information link from diagnostic information selection area 730, a screen is shown that includes information about interactive program guide (IPG) events on the IPG screen. In one embodiment, the information-shown at the IPG screen is shown in Table 15. [t15]

TABLE 15

| Information | Example |
|---|---|
| Number of IPG screen items | 0 |
| Date when the IPG events were loaded | May 17, 1999 |
| Date and time the IPG data was loaded in-band (ib) | loaded 5/17 |
| or out-of-band (oob) | 12:27 ib |
| Action that caused the IPG data to be loaded | Boot |
| Number of total events of IPG data available in this | 1681 events |
| day's data | |
| Number of PPV events available in this day's data | 1118 ppvEvents |

BFS Information

If a user selects the BFS information link from diagnostic information selection area 730, a screen is shown that includes information including how much total data has been read from in-band and out-of-band carousels. The BFS screen also includes information about when certain common files were most recently read, if any errors occurred when they were read, and some performance information useful for fine-tuning the BFS data carousel rates. In one embodiment, the information shown at the BFS screen is shown in Table 16.

[t16]

TABLE 16

| Information | Example |
|---|---|
| Total Data Read | Total number of bytes read from the BFS |
| Total IB Read | Total number of bytes read from the in-band |
| | carousel |
| Total OOB Read | Total number of bytes read from the out-of- |
| | band carousel |
| Regions | Date, time, and version of the last region file |
| | (regions.dat) read from the BFS |
| Feat | Date, time, and version of the last feature |
| | authorization file read from the BFS |
| VCR | Date, time and version of the last VCR file |
| | read from the BFS |
| Config | Date, time, and version of the last |
| | configuration file read from the BFS |
| Logos | Date, time, and version of the last logo file |
| | read from the BFS |
| ASP | Date, time, and version of the last |
| | application management file read from the |
| | BFS |
| Channel | Date, time, and version of the last channel |
| | file read from the BFS |
| Language | Date, time, and version of the last language |
| | file read from the BFS |
| IPG | Date, time, and version of the last IPG file |
| | read from the BFS |
| Other (for | Date, time, and version of the last indicated |
| example, engine.PAS) | file read from the BFS, for example |
| | CHECKERS.PAS |

PPV and Authorization Information

If a user selects the PPV and authorization information link from diagnostic information selection area 730, a screen is shown that includes information about PPV and authorization transactions, such as how many PPV credits are available, information about poll requests and purchased entitlements. The cable company assigns a number of credits to each customer to avoid non-payment of PPV purchases. The PPV and authorization information is shown on the PPV information screen. Information about past and pending PPV purchases is on the PPV Past and PPV Pending NVRAM screens. The PPV Event screen shows information about PPV events in general. In one embodiment, the PPV authorization and information screen includes the information shown in Table 17.

[t17]

TABLE 17

| Field | Shows |
|---|---|
| PPV Credits | Number of PPV credits available |
| Last Poll | Date and time when the set-top received the last |
| RequestReceived | PPV purchasespoll request from the billing system |
| Last Poll Request | Date and time when the set-top replied to the last |
| Sent | poll request |
| Poll Request | The amount of time that the poll reply is delayed on |
| Reply Delay | a delayedRequest |
| Last Poll Request | The type of poll request for the last poll (Delayed, |
| Type | Immediate, ora dash if no poll was received on this |
| | boot) |
| Responding To | Whether or not the set-top responded to the last |
| Last Poll | poll. All set-topsreceive a PPV event poll request |
| | from the DNCS hourly. If thesecure micro for a set- |
| | top does not have any unacknowledged PPV |
| | information to send back to the DNCS, it does not |
| | reply and thus the Responding to Last Poll field |
| | shows NO. If there is some PPV activity to report, the |
| | field shows YES. When a set-top is specifically |
| | polled (not the hourly broadcast poll), it always |
| | responds. |
| Last PPV enabled | Why a set-top may be in IPPV or RPPV mode1 way |
| check | set-top is IPPV mode2 way set-top is in PPV |
| | modeFEAT set-top is enabled to use IPPV-FEAT set- |
| | top is disabled for IPPVDNCS PPV is enabled |
| | (determined by DNCS setting on the secure |
| | elements page-DNCS PPV is disabled |
| Last PM | The last purchase manager (PM) exception received |
| exception | |
| Purchase | ID numbers of the entitlements that were purchased |
| entitlement IDs | and not yet collected or completed |

Past and Pending PPV Purchases

If a user selects the past and pending PPV purchases link from diagnostic information selection area 730, a screen is shown that includes information about PPV purchases and the storage of this information in the set-top's NVRAM. There are two areas of NVRAM: pending and past. You can find the past information on the PPV Past NVRAM screen, and the pending information on the PPV Pending NVRAM screen. The PPV Pending NVRAM screen contains information about upcoming purchased events or purchased events currently in progress. The PPV Past NVRAM screen shows a history of PPV purchases. The information shown in PPV pending screen according to one embodiment of the present invention is shown in Table 18.

[18]

TABLE 18

| Field | Shows |
|---|---|
| Info For Slot | Slot number of the pending PPV purchase for which |
| | information displays on the screen (there are eight slots |
| | available). Press the left or right arrow button to cycle |
| | between slots |
| Timer Is | Date and time when the NVRAM timer goes off |
| Going Off At | |
| Timer Type | Type of timer. A rollover timer shows the time when the |
| | event is moved from the pending to the past area. A |
| | purchase timer applies to a PPV program that goes to the |
| | secure micro. An error timer is a timer that alerts the |
| | viewer of an error when it goes off. A collection timer |
| | shows the time the timer is removed from NVRAM |
| | because the viewer did not acknowledge the error |
| Entitlement | Entitlement ID for the event as assigned by the DNCS |
| ID | |
| Service | Service index for the service and the channel number |
| Index | |
| IPG Start | IPG start time of the purchased event. This is used to |
| Time | check if an event is blocked |
| IPG Duration | IPG duration of the purchased event in minutes. This is |
| (Minutes) | used to check if an event is blocked |
| PPV Start | Date and time when the PPV event starts |
| Time | |
| PPV | Duration of the PPV event in minutes |
| Duration | |
| (Minutes) | |
| Cancel Time | Date and time up to when the viewer can cancel the |
| | purchase |
| SM Open | Date and time when the secure micro window opens to |
| Time | allowpurchasing of the event |
| SM Close | Date and time when the secure micro window closes |
| Time | andpurchasing is no longer possible |
| Error Code | Error code if the timer type is error or collection |

Some of the information shown in the PPV past NVRAM screen according to one embodiment of the present invention is shown in Table 19

[t19]

TABLE 19

| Field | Shows |
|---|---|
| Info For Slot | Slot number of the past PPV purchase for which |
| | information displays on the screen |
| PPV Start Time | Time the PPV program started |
| Service Index | Service index for the service displayed for this |
| | channel and the channel number |
| PPV Duration | Duration of the PPV program in minutes |
| Minutes) | |

PPV Events

If a user selects the PPV events link from diagnostic information selection area 730, a screen is shown that includes information about the last PPV program that the viewer accessed. Table 20 shows some of the information that is shown on this screen according to an embodiment of the present invention.

[t20]

TABLE 20

| Field | Shows |
|---|---|
| Event Time | Date and time the event starts as defined by the PPV |
| | package (not the IPG start time) |
| Event | Duration of the event as defined by the PPV package (not |
| Duration | the IPG duration) and the purchase price of the event as |
| | shown to the viewer |
| Entitlement | Entitlement ID of the event as assigned by the DNCS |
| ID | |
| SM Open | Date and time when the secure micro window opens to |
| Time | allow purchasing of the event |
| SM Close | Date and time when the secure micro window closes and |
| Time | purchasing is no longer possible |
| Advertise | Date and time when the advertising window opens and |
| Open | displays the PPV buy screen |
| Advertise | Date and time when the advertising window closes and |
| Close | no longer displays the PPV buy screen |
| Phone Open | Date and time when the reservation phone number is |
| | displayed |
| Phone Close | Date and time when the reservation phone number is no |
| | longer displayed |
| Preview | Date and time when the preview window opens and |
| Open | displays a free preview of the program inside the inset |
| Preview | Date and time when the preview window closes and no |
| Close | longer displays the free preview |
| Cancel Time | Date and time up to when the viewer can cancel the |
| | purchase |
| Phone | Phone number to call to purchase the event if this is a |
| Number | reservation PPV program as displayed to the viewer |

EMM In formation

If a user selects the EMM information link from diagnostic information selection area 730, a screen is shown that includes information about the EMMs. Table 21 shows some of the information that is shown on this screen according to an embodiment of the present invention.

[t21]

TABLE 21

| Field | Shows |
|---|---|
| Num Valid | Number of valid EMMs received since last reboot |
| EMMs | |
| Status | Powerkey status. This field can show the following |
| | options: Ready Powerkey is initialized, set-top is |
| | ready for use Waiting EMM Waiting for EMM Waiting |
| | for GBAM Waiting for the time GBAM Waiting EUT |
| | Waiting for the Entitlement Unit Table to be loaded |
| In Band Open | Whether in-band staging is currently in progress |
| State | |
| Expires | Date and time when the set-top's Powerkey |
| | authorization expires if not refreshed by the DNCS. |
| | The DNCS refreshes all authorized set-tops once a |
| | day and the authorization lasts approximately 30 |
| | days |
| EMM | Total number of received and valid EMMs designated |
| | for this set-top |
| Time GBAM | Total number of received and valid time GBAMs |
| Prch GBAM | Number of received and valid GBAMs for purchased |
| | PPV events |
| App GBAM | Total number of received and valid application GBAMs |
| Ext GBAM | Total number of received and valid extended event |
| | GBAMs |
| ECM | Total number of received and valid entitlement |
| | control messages (ECM) |
| Last EUT | Date and time when the settop last read the EUT file |
| | on the BFS. The EUT file contains PPV entitlement IDs |
| | and other encryption and authorization information. |
| | The file is updated a few times an hour; any time |
| | entry of over 30 minutes could indicate a problem |
| Last DDS | Date and time of last DDS |
| Last FPM | Date and time of the last request for the Forward |
| | Purchase Message (FPM) |
| CA Time | Authenticated date and time received via Time |
| | GBAMs. This field should match the current time as |
| | reported on the LEDs |
| Update | Whether a new EUT has been detected on the network |
| Pending - | and has been queued up to read. This field shows |
| EUT | True while the settop is reading the new file and |
| | awaiting its installation. This field usually shows False |
| Prog Start | Date and time when the decryption for the current |
| | encrypted program started. If you tune away from the |
| | channel and tune back, the value resets to the current |
| | time, not when the movie began. An MPEG glitch or |
| | conditional access interruption may also reset this |
| | value |
| Prog End | Date and time when decryption on the previous |
| | encrypted event stopped. Typically, for a PPV event |
| | that runs from 8:00 to 9:48, the start time is 8:00 (or |
| | later if you joined the event in progress), and the end |
| | time is 9:48 |
| DDS | Whether an update is pending for DDS |
| Decrypt Status | Current status of the encrypted video signal (OK, |
| | Blackout, Not Authorized, No ECMs). Other messages |
| | may be seen under certain error conditions |
| Late Keys | Number of times that a program key decryption |
| | operation occurs after the program data arrives at the |
| | set-top. Macroblocking is a common artifact of this |
| | situation |
| Worst ECM | Worst time (in milliseconds) between ECM read |
| | operations |
| Num ISE Fails | Number of times the internal secure micro failed a |
| | command |
| Last Fail Cmd | Last command that failed on the internal secure micro |
| Timeouts/Cmd | Number of communication timeouts with the internal |
| | secure micro |
| Last Purch | Entitlement ID, date, and time of last PPV purchase |
| Attempt | attempt |
| Last Purch | Entitlement ID, date, and time of last PPV purchase |
| Success | success |
| Last | Last purchase device used and result |
| Device/Result | |
| Current EID | Current Entitlement ID authorizing the program |
| ECM PID | ECM PID for current program (0 indicates clear-to-air) |
| EAID Flags | EAID = Entitlement Agent ID for internal secure |
| | micro. /Has the EAID been installed? (1 = yes, |
| | 0 = no) D Digital Enabled A Analog Enabled In |
| | Interactive Enabled Ip IPPV EnabledThe last four |
| | messages are specific checkbox flags in the DNCS |
| | DHCT GUI for each individual set-top. For a properly |
| | staged box, all these fields should be set to 1 |
| EAID ESE | Same as the EAID Flags field, but applying to the ESE |
| | (external security interface, i.e. Smart Card). These all |
| | show 0 for current generation set-tops |

Passthru Messages

If a user selects the passthru messages link from diagnostic information selection area 730, a screen is shown that includes information about passthru messages. One embodiment of the present invention shows the information in Tables 22 and 23 this screen is selected.

[t22]

TABLE 22

| Information | Example |
|---|---|
| Time | Date and time when the set-top received the message |
| Type | Type of message. EAS indicates that the message was an |
| | emergency alert system (EAS) message. |
| | BFSFileHasChanged is a message that indicates to the |
| | set-top that some files on the BFS have changed. The |
| | set-top then reads the new files. ResetPIN indicates a |
| | message with an instruction to the set-top to change one |
| | of its PINs |

[t26]

TABLE 23

| This type of | |
|---|---|
| message | Can have these descriptions |
| EAS | EAS indicates this is an EAS message. A number |
| | indicates the message ID. A three-letter code |
| | indicates the code of the message |
| BFSFileHasChanged | First word of BFSFileHasChanged description |
| | indicates when the set-top must read in the new |
| | file: Now indicates the new file must be read in |
| | immediately Pwr indicates the new file must be |
| | read in when the set-top is powered off Time |
| | indicates the new file must be read no later than |
| | the time passed ChChg indicates the new file |
| | must be read when the viewer changes the |
| | channelSecond part of the description indicates |
| | which updated files theset-top must read: Ch/ |
| | indicates that the set-top must read the channel |
| | lineup information (chaninfo) A/indicates that the |
| | set-top must read the services file (aspinfo) Vcr/ |
| | indicates that the set-top must read the file with |
| | the VCR code listing (VCR_CODE.DAT) Cfg/ |
| | indicates that the set-top must read the |
| | configuration file (settop.cfg) Ipg/indicates that |
| | the set-top must read the IPG data Fea/indicates |
| | that the set-top must read the feature |
| | authorization file (featauth.dat) |
| ResetPIN | First part indicates which PIN to affect: Prch |
| | instructs the set-top to affect the purchase PIN |
| | Blck instructs the set-top to affect the blocking |
| | PINSecond part indicates what action the set-top |
| | must take: Enble instructs the set-top to enable |
| | the PIN Dsble instructs the set-top to disable the |
| | PIN |

Last Reset Information

If a user selects the last reset information link from diagnostic information selection area 730, a screen is shown that includes information about the last time a set-top was reset. The last reset information screen shows information gathered the last time the set-top rebooted due to the system watchdog timer having expired. This information will only be valid if the system initiated the reboot. The last reset information is used mostly to report reboots to the service provider. One embodiment of the present invention shows the information in Table 24 when this screen is selected.

[t24]

TABLE 24

| Field | Shows |
|---|---|
| Reset | The date and time at the last watchdog reboot. If there |
| Occurred At | is no valid information stored, this field indicates this |
| | and all other fields are not available |
| Free Sys | The amount of free system memory available at the last |
| Mem | watchdog reboot |
| Free Vid | The amount of free video memory available at the last |
| Mem | watchdog reboot |
| Service ID | The ID of the service that was running when the reboot |
| | occurred |
| Free Events | The number of free events available at the last watchdog |
| | reboot |
| Last Passthru | The time when the last Passthru message was received |
| Time | before the watchdog reboot occurred. If no Passthru |
| | message was received, this field shows a dash |
| Last Passthru | The type of Passthru message that last occurred before |
| Type | the watchdog reboot. If no Passthru message was |
| | received, this field shows a dash |
| Global App | The global application that was current at the watchdog |
| | reboot |
| Prev Global | The global application that was current just prior to the |
| App | one indicated in the Global App field above |
| Last Glob | Swap The time at which the last swap of global |
| App | applications occurred |
| Semaphore | A series of numbers indicating which Passport |
| Bitmap | semaphores were held at the watchdog reboot (0 |
| | indicates no semaphores held, 1 indicates a semaphore |
| | was held) |

MOD Information

If a user selects the MOD information link from diagnostic information selection area 730, a screen is shown that includes information about MOD. One embodiment of the present invention shows the information in Table 25 when this screen is selected.

[t23]

TABLE 25

| Field | Shows |
|---|---|
| Last Message | A description of the last MOD errorCONN:IP:PORT |
| | connection to server failedVCONN:IP:PORT |
| | connection to video pump failedNO ASSET: OID/TID |
| | no assets for the OID TID comboSESS: RSN/RSP |
| | SessionSetup failure DSMCCReason/Response codes |
| Last Error | When the last MOD error was sent |
| Server IP | IP address of the server |
| UDP Port | Port number where heartbeats are sent |
| Async Notify | Port number where ModDaemon listens for async |
| Port | messages from the server |
| Session Gateway | IP address of the session gateway |
| Service Group | Value of the service group (NFI) |
| ModServer | Pinging updates from the settop to the server |
| (ping) | |
| SessionGateway | Pinging updates from the settop to the session |
| (ping) | gateway |

MOD Purchases

If a user selects the MOD purchases link from diagnostic information selection area 730, a screen is shown that includes information about purchases of the MOD. One embodiment of the present invention shows the information in Table 26 when this screen is selected.

[t25]

TABLE 26

| Field | Shows |
|---|---|
| Purchases | Number of MOD purchases. This field may show additional |
| | purchase information in the following formatMM/DD HH: MI |
| | Title (month/day/hour: minutes)PID OID TID BilledFlag |
| | (1 = billed; 0 = not billed) |

MOD Events

If a user selects the MOD events link from diagnostic information selection area 730, a screen is shown that includes information about the last MOD program the viewer accessed. One embodiment of the present invention shows the information in Table 27 when this screen is selected.

[t27]

TABLE 27

| Field | Shows |
|---|---|
| MOD data built | Date and time when MOD data was generated in |
| | month/date hours:minutes format |
| NumTitles | Number of titles in the current modbfs file |
| NumOffers | Number of offers in the current modbfs file. |
| NumOffersTitles | Number of offers-titles in the current modbfs files. |
| | This may include offers with multiple titles attached. |
| NumPlaylists | Number of playlists in the current modbfs file |
| NumAssets | Number of assets in the current modbfs file |
| NumServices | Number of MOD service channels in the current |
| | modbfs file |
| NumServSch | Number of MOD service schedules in the current |
| | modbfs file (NFI) |

Although the description above contains many specificities, these should not be construed as limiting the scope of the invention but as merely providing illustrations of some of the presently preferred embodiments of this invention. Thus the scope of this invention should be determined by the appended claims and their legal equivalents.

1. A method for obtaining information from a set-top box comprising: using a graphical user interface (GUI) on a computer to input a unique identifier for said set-top box; using said unique identifier to establish a connection across a network between said computer and said set-top box; querying for one or more internal states of said set-top box; and receiving said internal states at said computer, in response.

2. The method of claim 1, wherein said internal states include a diagnostic state.

3. The method of claim 1 wherein said network comprises a first and second network layer.

4. The method of claim 3 wherein said first network layer is an intranet.

5. The method of claim 4 wherein said intranet includes one or more set-top boxes connected to one or more cable outlets, which are in turn connected to one or more nodes, which are in turn connected to an application server.

6. The method of claim 3 wherein said second network layer is an Internet.

7. The method of claim 3 wherein said second network layer is an intranet.

8. The method of claim 1 wherein said GUI comprises a web page.

9. The method of claim 1 wherein said GUI comprises a web page.

9. The method of claim 1 wherein said unique identifier comprises an IP address, a MAC address, or a serial number.

10. The method of claim 1 wherein said step of querying further comprises: generating a script at said computer; sending said script to an application server; and executing said script on said application server.

11. The method of claim 1 wherein said step of receiving further comprises: formatting said internal states into a web page at an application server; sending said web page to a web browser on said computer; and displaying said web page on said web browser.

12. The method of claim 1 further comprising determining if said set-top box can be maintained or repaired remotely using said internal states.

13. The method of claim 12 further comprising: performing a maintenance or a repair activity remotely, if said set-top box can be maintained or repaired remotely; and dispatching a service technician, if said set-top box cannot be maintained or repaired remotely.

14. The method of claim 2 wherein said diagnostic state comprises a system summary.

15. The method of claim 2 wherein said diagnostic state comprises an identity.

16. The method of claim 2 wherein said diagnostic state comprises feature authorizations.

17. The method of claim 2 wherein said diagnostic state comprises a version.

18. The method of claim 2 wherein said diagnostic state comprises a network configuration.

19. The method of claim 2 wherein said diagnostic state comprises tuning information.

20. The method of claim 2 wherein said diagnostic state comprises RF network information.

21. The method of claim 2 wherein said diagnostic state comprises MPEG information.

22. The method of claim 2 wherein said diagnostic state comprises hardware information.

23. The method of claim 2 wherein said diagnostic state comprises memory.

24. The method of claim 2 wherein said diagnostic state comprises system information.

25. The method of claim 2 wherein said diagnostic state comprises channel information.

26. The method of claim 2 wherein said diagnostic state comprises program guide events.

27. The method of claim 2 wherein said diagnostic state comprises broadcast file system information.

28. The method of claim 2 wherein said diagnostic state comprises pay-per-view information.

29. The method of claim 2 wherein said diagnostic state comprises an entitlement management message status.

30. The method of claim 2 wherein said diagnostic state comprises passthru messages.

31. The method of claim 2 wherein said diagnostic state comprises last reset state information.

32. The method of claim 1 wherein said step of querying comprises accessing a diagnostic selection area in said GUI.

33. An apparatus comprising: a graphical user interface (GUI) on a computer; a unique identifier for a set-top box that is input into said GUI and establishes a connection across a network between said computer and said set-top box; one or more internal states of said set-top box that are queried from said computer to said set-top box across said network and received at said computer, in response.

34. The apparatus of claim 33, wherein said internal states include a diagnostic state.

35. The apparatus of claim 33 wherein said network comprises a first and second network layer.

36. The apparatus of claim 35 wherein said first network layer is an intranet.

37. The apparatus of claim 36 wherein said intranet includes one or more set-top boxes connected to one or more cable outlets, which are in turn connected to one or more nodes, which are in turn connected to an application server.

38. The apparatus of claim 35 wherein said second network layer is an Internet.

39. The apparatus of claim 35 wherein said second network layer is an intranet.

40. The apparatus of claim 34 wherein said GUI comprises a web page.

41. The apparatus of claim 34 wherein said unique identifier comprises an IP address, a MAC address, or a serial number.

42. An apparatus comprising: a graphical user interface (GUI) on a computer; a unique identifier for a set-top box that is input into said GUI and establishes a connection across a network between said computer and said set-top box; a script that is generated at said computer and sent to an application server that is interposed between said computer and said set-top box; one or more internal states of said set-top box that are queried when said script is executed on said application server and received at said computer.

43. The apparatus of claim 42 further comprising: a web page having said internal states that is formatted and sent to said application server; and a web browser on said computer that receives said web page and displays said web page.

44. A system for obtaining information from a set-top box comprising: means for using a graphical user interface (GUI) on a computer to input a unique identifier for said set-top box; means for using said unique identifier to establish a connection across a network between said computer and said set-top box; means for querying for one or more internal states of said set-top box; and means for receiving said internal states at said computer, in response.

45. The system of claim 44, wherein said internal states include a diagnostic state.

46. The system of claim 44 wherein said network comprises a first and second network layer.

47. The system of claim 46 wherein said first network layer is an intranet.

48. The system of claim 47 wherein said intranet includes one or more set-top boxes connected to one or more cable outlets, which are in turn connected to one or more nodes, which are in turn connected to an application server.

49. The system of claim 46 wherein said second network layer is an Internet.

50. The system of claim 46 wherein said second network layer is an intranet.

51. The system of claim 44 wherein said GUI comprises a web page.

52. The system of claim 44 wherein said unique identifier comprises an IP address, a MAC address, or a serial number.

53. The system of claim 44 wherein said means for querying further comprises: means for generating a script at said computer; means for sending said script to an application server; and means for executing said script on said application server.

54. The system of claim 44 wherein said means for receiving further comprises: means for formatting said internal states into a web page at an application server; means for sending said web page to a web browser on said computer; and means for displaying said web page on said web browser.

55. The system of claim 44 further comprising means for determining if said set-top box can be maintained or repaired remotely using said internal states.

56. The system of claim 55 further comprising: means for performing a maintenance or a repair activity remotely, if said set-top box can be maintained or repaired remotely; and means for dispatching a service technician, if said set-top box cannot be maintained or repaired remotely.

57. The system of claim 44 wherein said means for querying is accomplished by means for accessing a diagnostic information selection area in said GUI.

58. A computer program product comprising a computer useable medium having computer readable program code configured to cause a computer to obtain information from a set-top box comprising: computer readable program code configured to cause a computer to enable a graphical user interface (GUI) which receives a unique identifier for said set-top box; computer readable program code configured to cause a computer to use said unique identifier to establish a connection across a network between said computer and said set-top box; computer readable program code configured to cause a computer to query for one or more internal states of said set-top box; and computer readable program code configured to cause a computer to receive said internal states at said computer, in response.

59. The computer program product of claim 58, wherein said internal states include a diagnostic state.

60. The computer program product of claim 58 wherein said computer network comprises a first and second network layer.

61. The computer program product of claim 60 wherein said first network layer is an intranet.

62. The computer program product of claim 61 wherein said intranet includes one or more set-top boxes connected to one or more cable outlets, which are in turn connected to one or more nodes, which are in turn connected to an application server.

63. The computer program product of claim 60 wherein said second network layer is an Internet.

64. The computer program product of claim 60 wherein said second network layer is an intranet.

65. The computer program product of claim 58 wherein said GUI comprises a web page.

66 The computer program product of claim 58 wherein said unique identifier comprises an IP address, a MAC address, or a serial number.

67. The computer program product of claim 58 wherein said computer readable program code configured to cause a computer to query further comprises: computer readable program code configured to cause a computer to generate a script at said computer; computer readable program code configured to cause a computer to send said script to an application server; and computer readable program code configured to cause a computer to execute said script on said application server.

68. The computer program product of claim 58 wherein said computer readable program code configured to cause a computer to receive further comprises: computer readable program code configured to cause a computer to format said internal states into a web page at an application server; computer readable program code configured to cause a computer to send said web page to a web browser on said computer; and computer readable program code configured to cause a computer to display said web page on said web browser.

69. The computer program product of claim 58 further comprising computer readable program code configured to cause a computer to determine if said set-top box can be maintained or repaired remotely using sa id internal states.
